(19) United States
(12) Patent Application Publication
(10) Pub. No.: US 2005/0013751 A1
(43) Pub. Date: Jan. 20, 2005

(54) Computer enclosure with photocatalyst device

(76) Inventors: Gwo-Yan Huang, Tu-chen (TW); Chih-Chien Hung, Tu-Chen (TW); Mu-Chi Hsu, Tu-Chen (TW); Wen Bin Chen, Shenzhen (CN); Chung-Hsin Lu, Tu-chen (TW); Wu-Kuang Chen, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/894,736

(22) Filed: Jul. 19, 2004

(30) Foreign Application Priority Data
Jul. 17, 2003 (CN) 03267793.6

(51) Int. Cl. B01J 19/08

(52) U.S. Cl. 422/186.3

(57) ABSTRACT

An environmentally friendly computer enclosure (20) includes a panel having a vent; and a photocatalyst device (1) mounted on the vent. The photocatalyst device includes an ultraviolet light source device (12), and a filter net (13) with a photocatalyst layer coated thereon. The photocatalyst layer preferably comprises titanium dioxide. The photocatalyst device is mounted on an outside of the vent. The ultraviolet light source device comprises at least one ultraviolet lamp tube or at least one ultraviolet light emitting diode. Soiled air output from the computer enclosure passes through the filter net that is coated with the photocatalyst layer of titanium dioxide. The soiled air is thus purified before being dissipated into the ambient environment.

### BACKGROUND OF THE INVENTION

1. Field of the Invention

The present invention relates to casings that house electronic equipment, and more particularly to a computer enclosure which can purify soiled air produced during operation of the computer.

2. Description of Prior Art

A photocatalyst is a substance that facilitates chemical reactions when it is exposed to photo irradiation, but without becoming transformed itself. Generally, photocatalysts are used for deodorizing, sterilizing, antibacterial applications, antifouling, and removal of toxic substances.

Titanium dioxide particles are one kind of typical photocatalyst. When the titanium dioxide particles are irradiated by ultraviolet rays with a wavelength less than 400 nanometers, electrons in the valence band of the titanium dioxide undergo a transition from the valence band to the conduction band due to absorption of the energy of the ultraviolet rays, and holes with positive charges are produced. Therefore, a plurality of electron-hole pairs is formed. The plurality of electrons and holes can react with water and oxygen molecules which contact surfaces of the titanium dioxide particles, to produce active free radicals such as free oxygen radicals, hydroxyl radicals etc. The free radicals are very powerful oxidants.

The free radicals produced are capable of decomposing organic dust and grease into carbon dioxide (CO₂), water (H₂O), etc. Therefore, carbon atoms contained in organic substances at the surface of the titanium dioxide particles are stripped from the organic substances and oxidized, thereby decomposing the organic substances. This decomposition kills bacteria, removes bad smells, and prevents adhesion of dirt to a surface that needs to be protected.

U.S. Pat. No. 6,462,947 discloses a computer enclosure that combines a photocatalyst and an ultraviolet light source as a means to purify air._ The computer enclosure comprises: a metal wire gauze filter positioned in an air input port of a face panel; an induced draft fan positioned behind the metal wire gauze filter to draw outside air into the air input port toward an air output port at a rear side of the computer enclosure; and an ultraviolet lamp installed in the computer enclosure to emit light onto a titanium dioxide coating on the face panel, the wire gauze filter, and an inside wall of the computer enclosure in order to purify air passing through the air input port and the air output port.

However, during operation of the computer, the air inside the computer enclosure gradually becomes soiled. Because the filter is mounted inside the air input port, the soiled air cannot be purified. The fan set inside the computer enclosure drives the soiled air directly into ambient air outside the computer enclosure, thereby polluting the environment. In addition, because the filter is set inside the computer enclosure, it is difficult to remove and replace the filter in the event of malfunction.

Therefore it is desired to provide an environmentally computer enclosure which can overcome the above-described problems, and purify soiled air produced by operation of the computer and prevent pollution of the environment.

### BRIEF SUMMARY OF THE INVENTION

Accordingly, an object of the present invention is to provide an environmentally friendly computer enclosure which can purify soiled air produced by operation of the computer.

Another object of the present invention is to provide a computer enclosure with an air purifying device that is easily removed and replaced in the case of malfunction.

To achieve the above-mentioned objects, an environmentally friendly computer enclosure in accordance with a preferred embodiment of the present invention includes a panel having a vent; and a photocatalyst device mounted on the vent. _The photocatalyst device comprises an ultraviolet light source device, and a filter net with a photocatalyst layer coated thereon. The photocatalyst layer preferably comprises titanium dioxide. The photocatalyst device is mounted on an outside of the vent. The ultraviolet light source device comprises at least one ultraviolet lamp tube or at least one ultraviolet light emitting diode. Soiled air output from the computer enclosure passes through the filter net that is coated with the photocatalyst layer of titanium dioxide. The soiled air is thus purified before being dissipated into the ambient environment.

In achieving the said objects of the invention herein, technological means and structural innovations are disclosed herein to demonstrate the most feasible embodiments. In particular, the following detailed description taken in conjunction with the appended drawings will enable a further understanding of the present invention, wherein:

### BRIEF DESCRIPTION OF THE DRAWINGS

FIG. 1 is an isometric view of a photocatalyst device in accordance with the preferred embodiment of the present invention; and

FIG. 2 is an isometric view of an environmentally friendly computer enclosure in accordance with the preferred embodiment of the present invention, showing the photocatalyst device of FIG. 1 mounted thereon.

### DESCRIPTION OF THE PREFERRED EMBODIMENTS

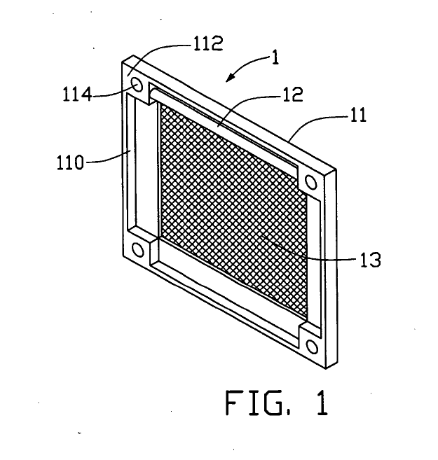

Referring to FIG. 1, a photocatalyst device 1 in accordance with the preferred embodiment of the present invention comprises a frame 11 defining an opening in a center thereof, a filter net 13 covering the opening, four airproof blocks 110 around a periphery of the frame 11, and an ultraviolet light source device 12 mounted at an inside of a top one of the airproof blocks 110. Four screw holes 114 are defined in four corners 112 of the frame 11 respectively. The filter net 13 comprises a plurality of crossed metal threads with a layer of photocatalyst coated thereon. In the preferred embodiment, the photocatalyst layer comprises titanium dioxide. The ultraviolet light source device 12 comprises an ultraviolet lamp tube or an ultraviolet light emitting diode. Alternatively, a plurality of ultraviolet light source devices can be mounted on four sides of the frame 11, for uniformly providing ultraviolet rays to the photocatalyst layer.

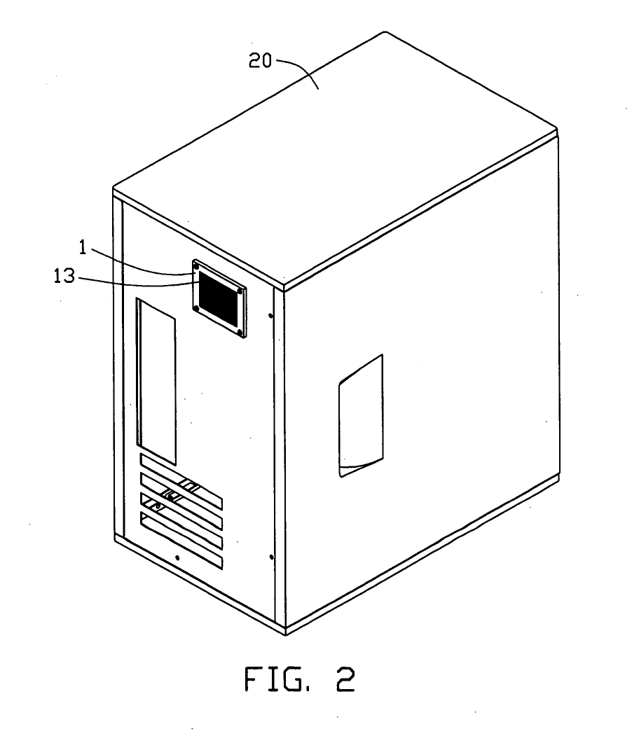

Referring to FIGS. 1 and 2, the environmentally friendly computer enclosure 20 comprises a panel having a vent therein, with the photocatalyst device 1 mounted on an outside of the vent. Further, the computer enclosure 20 defines four screw holes corresponding to the screw holes 114 of the frame 11, so that the photocatalyst device 1 is tightly mounted on the computer enclosure 20 by screws. This ensures that air output from the computer enclosure passes through the filter net 13 that is coated with the photocatalyst layer of titanium dioxide. Further, because the photocatalyst device 1 is mounted on the outside of the vent, it is easily removed and replaced.

In use, a fan is positioned in the computer enclosure 20. The fan draws outside air into the computer enclosure 20 via an air inlet (not shown), and soiled air produced by operation of the computer is dissipated away from the computer enclosure 20 via the vent. Because the photocatalyst layer of titanium dioxide is irradiated by ultraviolet rays emitted from the ultraviolet light source device 12, a plurality of free radicals is produced. The free radicals purify the air by killing bacteria and neutralizing bad smells, and prevent adhesion of dirt to the filter net 13. The soiled air passing through the vent is purified before being dissipated into the ambient environment, so that pollution of the ambient environment is prevented.

Further, because the photocatalyst device 1 is mounted outside of the computer enclosure 20, it is easily removed and replaced in the case of malfunction.

In an alternative configuration, the photocatalyst device 1 can be mounted on an inside of the vent. In a further alternative embodiment, the computer enclosure 20 can comprise another photocatalyst device 1 mounted on the air inlet port, for purifying air that enters the computer enclosure 20. The photocatalyst device(s) 1 can also alternatively be fixed to the computer enclosure 20 by clipping, welding, or other suitable means.

It is understood that the invention may be embodied in other forms without departing from the spirit thereof. Thus, the present examples and embodiments are to be considered in all respects as illustrative and not restrictive, and the invention is not to be limited to the details given herein.

1. An environmentally friendly computer enclosure comprising:
a panel having a vent; and
a photocatalyst device mounted on the vent, the photocatalyst device comprising an ultraviolet light source device, and a filter net with a photocatalyst layer coated thereon.

2. The computer enclosure of claim 1, wherein the photocatalyst device is mounted on an outside of the vent.

3. The computer enclosure of claim 1, wherein the ultraviolet light source device comprises an ultraviolet lamp tube.

4. The computer enclosure of claim 1, wherein the ultraviolet light source device comprises an ultraviolet light emitting diode.

5. The computer enclosure of claim 1, wherein the filter net comprises a plurality of crossed metal threads.

6. The computer enclosure of claim 1, wherein the photocatalyst comprises titanium dioxide.

7. The computer enclosure of claim 1, wherein the photocatalyst device is mounted on an inside of the vent.

8. An environmentally friendly computer enclosure comprising:
a casing having a vent and an air inlet; and
two photocatalyst devices mounted separately on the vent and the air inlet, each of the photocatalyst devices comprising an ultraviolet light source device, and a filter net with a photocatalyst layer coated thereon.

9. An environmentally friendly computer enclosure comprising:
a back panel located on a back side of a computer enclosure and having a vent with outwardly blowing airflow from a fan mounted in the computer enclosure; and
a photocatalyst device confronting the vent and including a filter net with a photocatalyst layer coated thereon.

10. The enclosure as claimed in claim 9, wherein said filter net is exposed to an ultraviolet light source device.
